(19) United States
(12) Patent Application Publication
(10) Pub. No.: US 2008/0186746 A1
(43) Pub. Date: Aug. 7, 2008

(54) Power Supply System

(75) Inventor: Anton Cornelis Blom, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,015

(22) PCT Filed: Jan. 18, 2006
(86) PCT No.: PCT/IB06/50188

§ 371 Date: Jul. 16, 2007

(30) Foreign Application Priority Data
Jan. 19, 2005 (EP) 05100311.9

(51) Int. Cl. H02M 7/04

(52) U.S. Cl. 363/67

(57) ABSTRACT

A power supply system (1) comprises a power brick (3) which comprises a power converter (30) arranged in a first housing (2). The power converter (30) converts an AC-mains input voltage (VM) into an AC-output voltage (VO) which has a higher frequency than the AC-mains input voltage (VM). A power supply circuit (7) supplies a DC-voltage (PVi) to an application (8). The power supply circuit (7) and the application (8) both being arranged in a second housing (6) mechanically separated from the first housing (2). A cable (5) interconnects the power brick (3) and the power supply circuit (7) to supply the AC-output voltage (VO) to the power supply circuit (7). The power supply circuit (7) comprises a rectifier circuit (RE1, RE2, RE3) which rectifies the AC-output voltage (VO) to supply the DC-voltage (PVi) to the application (8).

### FIELD OF THE INVENTION

The invention relates to a power supply system comprising a mechanically separated power brick and a power supply circuit with an application. The invention further relates to the power brick for use in the power supply system and the power supply circuit for use in the power supply system.

### BACKGROUND OF THE INVENTION

In many applications a power supply is used which is mechanically separated from the application which requires the power supply output voltages. Such application is, for example, a laptop, an inkjet printer, a LCD monitor, or a mobile handheld device. The mechanically separated power supply, which is also referred to as power brick, converts the AC-mains voltage into either a single or multiple lower AC-voltage(s) which has (have) the mains frequency, or into one or more DC-voltage(s).

For applications below about 100 Watts, these existing power bricks can handle their dissipation easily if suitably designed electronically and thermally. For applications between 100 and 160 Watts, a lot of special measures have to be implemented to deal with the dissipation. For applications above 160 Watts the extreme dissipation does not allow a useful design of a power brick.

### SUMMARY OF THE INVENTION

It is an object of the invention to provide a power brick which has a lower dissipation.

A first aspect of the invention provides a power supply system as claimed in claim 1. A second aspect of the invention provides a power brick for use in the mechanically separated power supply system as claimed in claim 9. A third aspect of the invention provides a power supply circuit for use in the power supply system and comprising the transformer and the rectifier as claimed in claim 10. Advantageous embodiments are defined in the dependent claims.

The power supply system in accordance with the first aspect of the invention comprises a power brick and a combination of a power supply circuit and an application. The power brick and the combination are arranged in mechanically separated housings. A cable transports the AC-output voltage of the power brick to the power supply circuit. The power brick comprises a converter to convert the AC-mains input voltage into an AC-output voltage which has a higher frequency than the AC-mains input voltage. For example, the AC-mains input voltage with a frequency of 50 Hz (or 60 Hz) is converted into the AC-output voltage which has a frequency in a kHz or MHz range. The power supply circuit comprises a rectifier circuit which rectifies the AC-output voltage and supplies a DC-output voltage to the application.

U.S. Pat. No. 5,737,203 discloses a power conversion circuit providing multiple regulated outputs from a single power supply. A power switching stage, which comprises a half or a full bridge, converts a DC-input voltage into an AC-output voltage which is a quasi-square wave. A power supply circuit receives the AC-output voltage and comprises three power converters to supply three power supply voltages. Each one of the three power converters comprises a transformer which a primary winding which is arranged in series with a series resonance capacitor. The series arrangement of the primary winding and the capacitor is connected to receive the AC-output voltage. A secondary winding of the transformer is connected to a rectifier to obtain a DC-output voltage. Filters filter the DC-output voltages to obtain the power supply voltages. However, all these circuits and the application are present in the same housing which has to be relatively large because of the high dissipation in the power supply circuits.

It is known to decrease the volume of the housing of an application by mechanically separating the complete power supply and the application. The complete power supply is put into a separate housing and is referred to as the power brick. The application receives the DC-voltages required from the power brick. The power brick supplies the power supply voltages via a cable to the application. In the present invention, only the power switching stage and the associated transformer is taken out of the housing of the application, and the rectifiers are left in the housing of the application. Preferably, the mains-isolation is provided in the transformer of the power brick. This enables to use small HF-transformers which do not require mains-isolation in the application if the AC-output voltage of the power brick has to be transformed to another amplitude. The combination of the small HF-transformers and the rectifiers is referred to as the power supply circuit. The power brick now supplies an AC-voltage to the power supply circuit, and the power supply circuit generates the DC-voltages required by the application. The power supply circuit and the application are present in the same housing. Consequently, the dissipation in the power brick will be lower and the housing of the power brick may be smaller, or the power brick may supply a higher power if the same housing is used. It has to be noted that the power supply circuit and the application are referred to as separate units, but that, in general, an application may be understood to comprise the power supply circuit. In the present document, the application is referring to the units of the application except the power supply circuit such that the power supply circuit is defined as the unit which supplies power supply voltages to the units of the application.

In an embodiment in accordance with the invention as claimed in claim 2, the converter comprises a half or a full bridge converter to convert the AC-mains voltage into the AC-output voltage having the higher frequency.

In an embodiment in accordance with the invention as claimed in claim 3, the power converter supplies the AC-output voltage with an amplitude which is lower than the amplitude of the AC-mains voltage to prevent unsafe situations when touched.

In an embodiment in accordance with the invention as claimed in claim 4, the power converter is mains isolated to prevent unsafe situations when touched.

In an embodiment in accordance with the invention as claimed in claim 5, the power converter comprises a rectifier which rectifies the AC-mains input voltage to obtain a DC-mains input voltage. A preconditioner receives the DC-mains input voltage and supplies a preconditioned voltage at its output. An LLC-converter converts the preconditioned voltage into the AC-output voltage which is mains separated. Such a series arrangement of a preconditioner and an LLC-converter is able to convert the AC-mains input voltage into the AC-output voltage which high efficiency while the harmonics drawn from the mains are minimized. An LLC converter is a converter based on a half-bridge or full-bridge switching stage, wherein the load is connected in series with a series arrangement of a first inductor and a first capacitor. A second inductor is arranged in parallel with the load. In total two inductors and one capacitor is required, resulting in the abbreviation LLC.

In an embodiment in accordance with the invention as claimed in claim 6, the power supply circuit comprises a transformer to transform the AC-output voltage into a transformed AC-output voltage which has a predetermined output amplitude. The rectifier circuit rectifies the transformed AC-output voltage to obtain the DC-output voltage. Such a transformer enables to transform the high frequent AC-output voltage to a desired level. If the frequency of the high frequent AC-output voltage is selected sufficiently high, the dimensions of the transformer will be relatively small.

In an embodiment in accordance with the invention as claimed in claim 7, the converter supplies the AC-output voltage having a frequency which is at least 100 times higher than the frequency of the AC-mains voltage. This enables the use of relatively small high frequent transformers.

In an embodiment in accordance with the invention as claimed in claim 8, the power supply circuit and the application form a unit which is one out of the list of: a mobile handheld device, an inkjet printer, a laptop, a monitor or a television comprising a cathode ray tube or a matrix display. More in general, the present invention is especially interesting for applications wherein the dimensions of the power brick should be minimal. Or said differently, wherein the power brick in accordance with the invention is able to supply an as large as possible output power for prescribed dimensions of the power brick.

These and other aspects of the invention are apparent from and will be elucidated with reference to the embodiments described hereinafter.

### BRIEF DESCRIPTION OF THE DRAWINGS

In the drawings:

FIG. 1 shows an embodiment of the power supply system which comprises a power brick and a combination of a power supply circuit and an application which are arranged in separate housings in accordance with the invention,

FIG. 2 shows a block diagram of an embodiment of the power converter of the power brick,

FIG. 3 shows a block diagram of another embodiment of the power converter of the power brick, and

FIG. 4 shows another embodiment of the power supply system.

### DETAILED DESCRIPTION OF THE PREFERRED EMBODIMENT

The same references in different Figures refer to the same items having the same meaning or the same function. An item which is indicated by a combination of capital letters followed by an index i is used to indicate an arbitrary one of the items indicated by capital letters. A specific one of these items is indicated by the same combination of capital letters followed by a number.

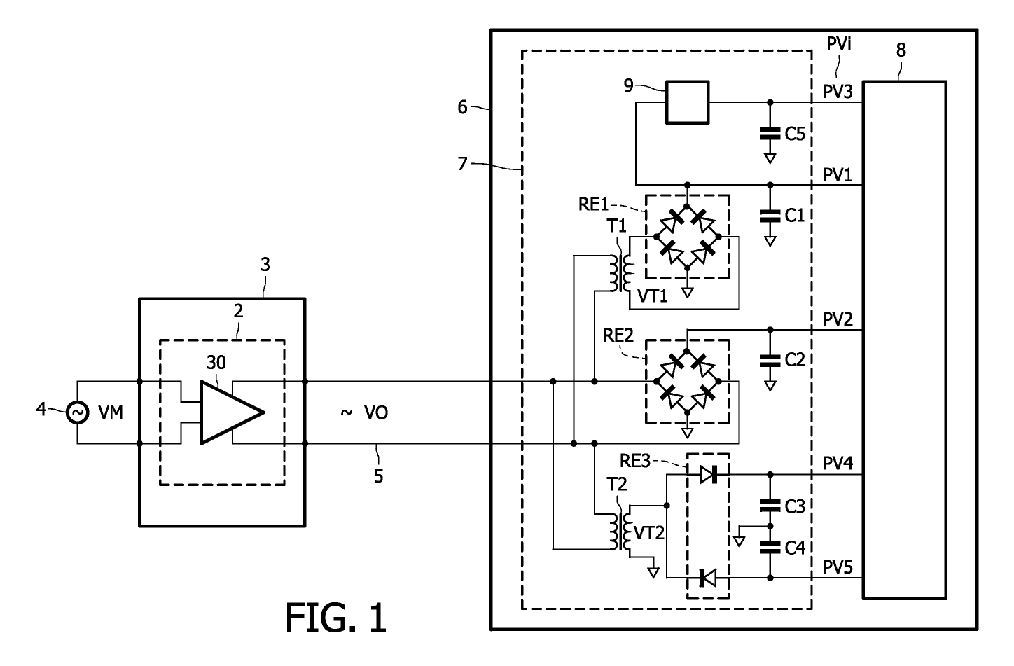

FIG. 1 shows an embodiment of the power supply system which comprises a power brick and a combination of a power supply circuit and an application which are arranged in separate housings in accordance with the invention.

The power brick 3 comprises a housing 2 which contains the power converter 30. The power converter 30 receives the AC-mains input voltage VM from the mains 4 and supplies the AC-output voltage VO. The power converter 30 converts the AC-mains input voltage VM which has a relatively low frequency of 50 or 60 Hz into the AC-output voltage VO which has a higher frequency than the frequency of the AC-mains input voltage VM.

A further housing 6, which is mechanically separated from the housing 2, comprises a power supply circuit 7 and an application 8. The power supply circuit 7 receives the AC-output voltage VO from the power brick 3 via the cable 5. The power supply circuit 7 supplies DC-voltages PVi to the application 8. In the example shown in FIG. 1, the power supply circuit 7 supplies five DC-voltages PV1 to PV5 to the application 8. Although for the ease of elucidation the power circuit 7 and the application 8 are shown as separate items, in fact the power circuit 7 together with the application 8 is often also referred to as the application.

A rectifier circuit RE2 rectifies the AC-output voltage VO to obtain the DC-voltage PV2 across the smoothing capacitor C2. The level of the DC-output voltage PV2 is about the same as the peak value of the AC-output voltage VO. Of course, the actual level of the DC output voltage PV2 is usually somewhat lower than this peak value due to the current drawn by the load of the application on this power supply output. The rectifier RE2 is shown to be a full bridge rectifier, but alternatively a single rectifier element may be used. However, such a single rectifier causes an asymmetrical load on the power brick 3.

A transformer T1 receives the AC-output voltage VO across a primary winding and transforms the AC-output voltage VO into a transformed AC-output voltage VT1 across a secondary winding. The transformed AC-output voltage VT1 is fed to the rectifier circuit RE1. The rectifier circuit RE1 rectifies the voltage VT1 to generate the DC-output voltage PV1 across the smoothing capacitor C1. Because the ratio of the number of windings of the primary winding and the secondary winding of the transformer T1 can be selected at will, it is possible to select the level of the DC-output voltage PV1 at will. By way of example only, the rectifier circuit RE1 comprises a full bridge rectifier. The rectifier RE1 is shown to be a full bridge rectifier, but alternatively a single rectifier element may be used. However, again, such a single rectifier causes an asymmetrical load on the power brick 3.

A transformer T2 receives the AC-output voltage VO across a primary winding and transforms the AC-output voltage VO into a transformed AC-output voltage VT2 across a secondary winding. The transformed AC-output voltage VT2 is fed to the rectifier circuit RE3 which rectifies the voltage VT2 to generate the DC-output voltages PV4 and PV5 across the smoothing capacitors C3 and C4, respectively. The rectifier circuit RE3 comprises two anti-parallel arranged diodes. One of the diodes supplies the rectified voltage in a first polarity to the capacitor C3, while the other diode supplies the rectified voltage in a polarity opposite to the first polarity to the capacitor C4. Again, because the ratio of the number of windings of the primary winding and the secondary windings of the transformer T2 can be selected at will, it is possible to select the level of the DC-output voltages PV4 and PV5 at will. By way of example, the rectifier circuit RE3 comprises two rectifier diodes for single phase rectification. Such a topology is preferably used if a symmetrical positive and negative power supply voltages are required, for example for an audio amplifier.

A DC-DC converter 9 receives the DC-output voltage PV1 and supplies the DC-output voltage PV3 across the smoothing capacitor C5. Such a DC-DC converter is especially advantageous if a DC-output voltage PV3 is required with higher accuracy than possible by directly rectifying the AC-output voltage VO. The transformers T1, T2 are especially advantageous if an isolated DC-output voltage PVi is required or a voltage with a level lower or higher than possible by directly rectifying the AC-output voltage VO. The DC-DC converter 9 may be an up-converter or a down-converter, and the transformers T1, T2 may transform the AC-output voltage VO to a lower or a higher amplitude.

The housing 2 of the power brick 3 can be relatively small because the dissipation in the rectifiers REi does not anymore contribute to the temperature rise of the power brick 3. Further, of course, these rectifiers REi including their heat-sinks (if required) do not require space in the power brick 3. The extra amount of space required in the housing 6 is very limited, the rectifiers REi are small. Also the transformers T1, T2 are small because the frequency of the AC-output voltage VO is higher than the frequency of the AC-mains input voltage. It is advantageous to select the frequency of the converter 30 much higher than the frequency of the mains 4 such that the transformers T1, T2 are high frequency transformers which are very small compared to transformers which have to transform the mains voltage VM. Preferably, the frequency of the converter is selected to be at least 100 times higher than the frequency of the mains.

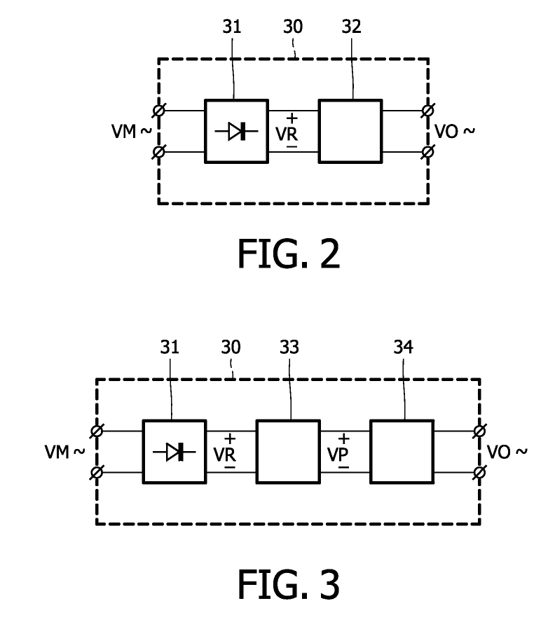

FIG. 2 shows a block diagram of an embodiment of the power converter of the power brick. The power converter 30 comprises a rectifier and a buffer capacitor 31 which rectifies and buffers the AC-mains voltage VM to obtain the rectified and buffered mains voltage VR. A half or a full bridge converter 32 converts the rectified mains voltage VR into the AC-output voltage VO which has the higher frequency than the AC-mains voltage VM. A half or full bridge converter 32 as such is well known in the art. Alternatively, a single transistor resonant converter may be used to obtain the high frequent AC-output voltage. These so called class-E converters as such are known from transmitter applications and from electronic drivers for small fluorescent lamps.

FIG. 3 shows a block diagram of another embodiment of the power converter of the power brick. The power converter 30 comprises the rectifier 31 which rectifies the AC-mains input voltage VM to obtain a rectified mains input voltage VR. A pre-conditioner 33 receives the DC-mains input voltage VR to supply a pre-conditioner output voltage VP, and a LLC-converter 34 converts the pre-conditioner output voltage VP into the AC-output voltage VO which is mains separated. Such a series arrangement of a pre-conditioner and an LLC converter as such is well known in the art.

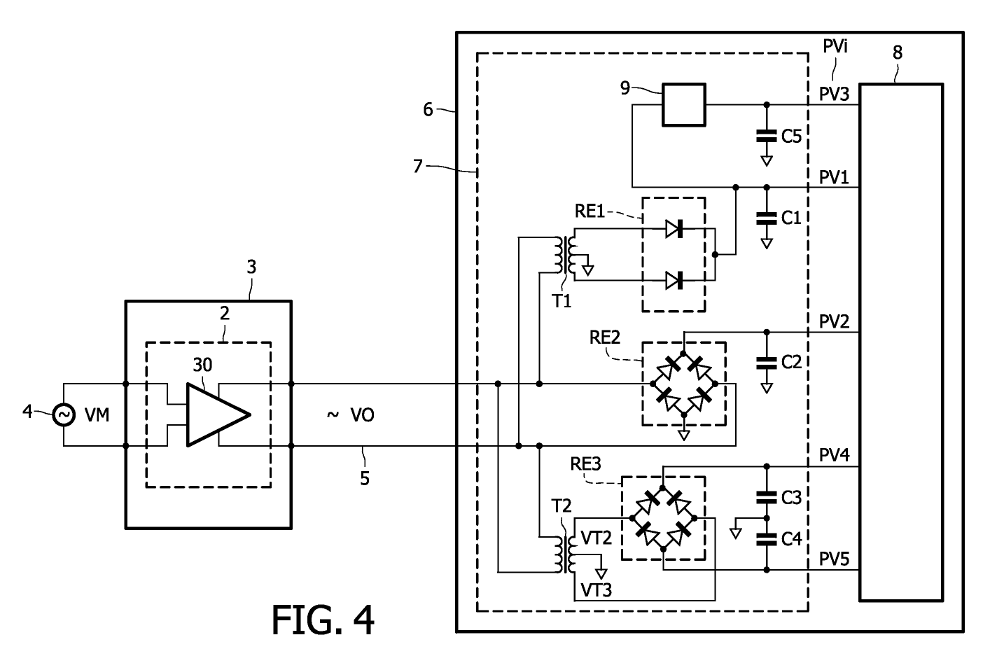

FIG. 4 shows another embodiment of the power supply system. This power system is based on the power system shown in FIG. 1. Now, alternatives are shown to generate the DC-output voltages PV1 and PV4, PV5.

The transformer T1 now comprises two series arranged secondary windings of which the center point is connected to the reference voltage which usually is ground. The rectifier circuit RE1 now comprises two single rectifiers (usually diodes) instead of the full bridge rectifier. The diodes are poled identically and are interconnected at the smoothing capacitor C1. Again a symmetrical load of the power brick 3 is obtained.

The transformer T2 receives the AC-output voltage VO across a primary winding and now transforms the AC-output voltage VO into two transformed AC-output voltages VT2 and VT3 across respective secondary windings. The secondary windings are arranged in series and their junction is connected to a reference voltage. The transformed AC-output voltages VT2 and VT3 are fed to the rectifier circuit RE3 which rectifies the voltages VT2 and VT3 to generate the DC-output voltages PV4 and PV5 across the smoothing capacitors C3 and C4, respectively. Again, because the ratio of the number of windings of the primary winding and the secondary windings of the transformer T2 can be selected at will, it is possible to select the level of the DC-output voltages PV4 and PV5 at will. The rectifier circuit RE3 now comprises a full bridge rectifier of which the inputs are connected across the series arrangement of the secondary windings and of which the outputs are arranged across the series arrangement of the smoothing capacitors C3 and C4. The junction of the capacitors C3 and C4 is connected to the reference voltage. Such a topology is preferably used if a symmetrical positive and negative power supply voltages are required, for example for an audio amplifier, and a symmetrical load of the power brick should be obtained.

It should be noted that the above-mentioned embodiments illustrate rather than limit the invention, and that those skilled in the art will be able to design many alternative embodiments without departing from the scope of the appended claims.

For example the transformers T1, T2 may be auto-transformers. Such transformers are smaller than transformers which have a primary and a secondary winding. The rectifier configurations shown are examples only, for example, also voltage multiplying rectifier circuits may be used.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A power supply system (1) comprising:
a power brick (3) comprising a first housing (2) and a power converter (30) for converting an AC-mains input voltage (VM) into an AC-output voltage (VO) having a higher frequency than the AC-mains input voltage (VM),
a power supply circuit (7) for supplying a DC-voltage (PVi) to an application (8), the power supply circuit (7) and the application (8) both being arranged in a second housing (6) mechanically separated from the first housing (2), and
a cable (5) interconnecting the power brick (3) and the power supply circuit (7) for supplying the AC-output voltage (VO) to the power supply circuit (7), wherein
the power supply circuit (7) comprises a rectifier circuit (RE1, RE2, RE3) for rectifying the AC-output voltage (VO) to supply the DC-voltage (PVi) to the application (8).

2. A power supply system (1) as claimed in claim 1, wherein the power converter (30) comprises a rectifier (31) for rectifying the AC-mains voltage (VM) to obtain a rectified mains voltage (VR), and a half or a full bridge converter (32) for converting the rectified mains voltage (VR) into the AC-output voltage (VO) having the frequency higher than the AC-mains voltage (VM).

3. A power supply system (1) as claimed in claim 1, wherein the power converter (30) is arranged to supply the AC-output voltage (VO) having an amplitude which is lower than an amplitude of the AC-mains voltage (VM).

4. A power supply system (1) as claimed in claim 1, wherein the power converter (30) is arranged to provide mains isolation.

5. A power supply system (1) as claimed in claim 1, wherein the power converter (30) comprises
a rectifier (31) for rectifying the AC-mains input voltage (VM) to obtain a DC-mains input voltage (VR),
a preconditioner (33) for receiving the DC-mains input voltage (VR) to supply a preconditioned voltage (VP), and
an LLC converter (34) for converting the preconditioned voltage (VP) into the AC-output voltage (VO) being mains separated.

6. A power supply system (1) as claimed in claim 1, wherein the power supply circuit (7) comprises a transformer (T1, T2) for transforming the AC-output voltage (VO) to obtain a transformed AC-output voltage (VT1; VT2, VT3) having a desired output amplitude, and wherein the rectifier circuit (RE1; RE3) is arranged for rectifying the transformed AC-output voltage (VT1; VT2, VT3) to obtain the DC-output voltage (PV1; PV4, PV5).

7. A power supply system (1) as claimed in claim 1, wherein the power converter (30) is arranged to supply the AC-output voltage (VO) having a frequency which is at least 100 times higher than the frequency of the AC-mains voltage (VM).

8. A power supply system (1) as claimed in claim 1, wherein the power supply circuit (7) and the application (8) form a unit which is one out of the list of: a mobile handheld device, an inkjet printer, a laptop, a monitor or a television comprising a cathode ray tube or a matrix display, or an electronic driven gas-discharge lamp.

9. A power brick (3) for use in the mechanically separated power supply system (1) as claimed in claim 1 and comprising the converter (30) for supplying the AC-output voltage (VO) having the higher frequency than the AC-mains input voltage (VM).

10. A power supply circuit (7) for use in the power supply system (1) as claimed in claim 6 and comprising the transformer (T1, T2) and the rectifier circuit (RE1, RE3).
